(19) United States
(12) Patent Application Publication
(10) Pub. No.: US 2007/0052385 A1
(43) Pub. Date: Mar. 8, 2007

(54) Streetlight powered by solar energy

(76) Inventor: Chen-Yueh Fan, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/515,526

(22) Filed: Sep. 5, 2006

(30) Foreign Application Priority Data
Sep. 7, 2005 (TW) 094215380

(51) Int. Cl. H02J 7/00

(52) U.S. Cl. 320/101

(57) ABSTRACT

A streetlight powered by solar energy has a lamppost, a circuit panel, a rechargeable battery and a solar array. The lamppost has a post and a lampshade. The lampshade is mounted around the top end of the post and has a top recess. The rechargeable battery is mounted in the lampshade and storing electricity. The solar array is mounted in the top recess in the lampshade and recharges the rechargeable battery. The circuit panel is mounted in the lampshade and has a light. Therefore, the solar array can absorb solar energy and transfer solar energy to electric energy to store electricity in the rechargeable battery. Then the rechargeable battery supplies power to the light.

### BACKGROUND OF THE INVENTION

1. Field of the Invention

The present invention relates to a light, and especially streetlights in parks or on roads, which are powered by solar energy.

2. Description of the Related Art

With modern developments in technology, people's lives are more and more convenient. Therefore, demand for electricity is very critical. However, global resources necessary to generate electricity are being depleted, and the cost of petroleum is continually increasing. Therefore, many researchers are studying how to convert solar energy to electricity by new devices such as high efficiency solar arrays.

Conventional streetlights are powered by an external power source. The streetlights are outside such as on roads or in parks and are exposed to the sun. Therefore, converting solar energy to electricity to light will decrease the cost of illumination.

### SUMMARY OF THE INVENTION

The objective of the present invention is to provide a streetlight powered by solar energy, which absorbs sunlight and converts solar energy to electricity that causes the streetlight to emit light.

To achieve the foregoing objective, a streetlight powered by solar energy in accordance with the present invention comprises a lamppost, a circuit panel, a rechargeable battery and a solar array. The lamppost has a post and a lampshade. The lampshade is mounted around the top end of the post and has a top recess. The rechargeable battery is mounted in the lampshade and storing electricity. The solar array is mounted in the top recess in the lampshade and recharges the rechargeable battery. The circuit panel is mounted in the lampshade and has a light. Therefore, the solar array can absorb solar energy and transfer solar energy to electric energy to store electricity in the rechargeable battery. Then the rechargeable battery supplies power to the light.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a streetlight powered by solar energy in accordance with the present invention;

FIG. 2 is a perspective view in partial section of the streetlight in FIG. 1; and

FIG. 3 is a control circuit diagram of the streetlight in FIG. 1.

### DETAILED DESCRIPTION OF THE PREFERRED EMBODIMENTS

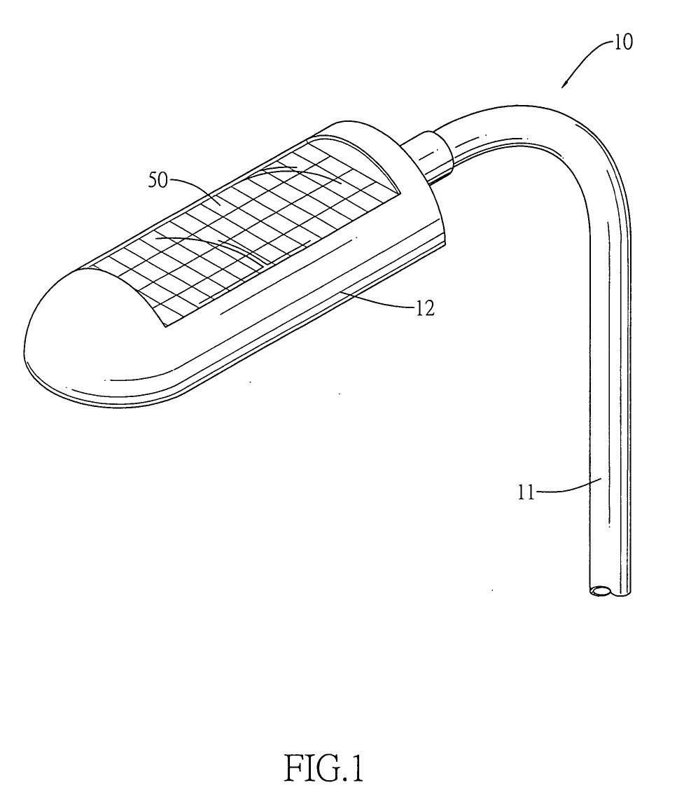

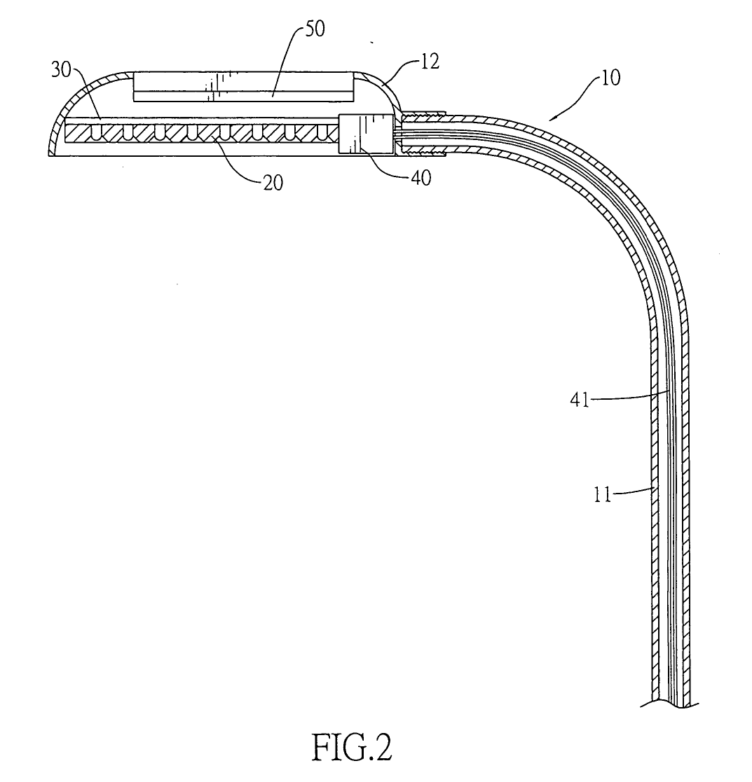

With reference to FIGS. 1 and 2, a streetlight powered by solar energy in accordance with the present invention comprises a lamppost (10), a rechargeable battery (40), a solar array (50) and a circuit panel (30).

The lamppost (10) comprises a post (11) and a lampshade (12). The post (11) has a top end and may be curved near the top end. The lampshade (12) is mounted on the post (11) at the top end, may be mounted around the top end of the post (11) and has a top recess and an open bottom.

The rechargeable battery (40) is mounted in the lampshade (12) and stores electricity.

The solar array (50) is mounted in the top recess in the lampshade (12), faces away from the lampshade (12), converts sunlight to direct current (dc) electricity and is connected to and recharges the rechargeable battery (40). The circuit panel (30) is mounted in the lampshade (12) and has a bottom surface, a light and a control circuit. The bottom surface faces the open bottom of the lampshade (12). The light is mounted on the bottom surface of the circuit panel (30), receives dc electricity from the rechargeable battery (40) and may be light emitting diodes (LEDs) (20).

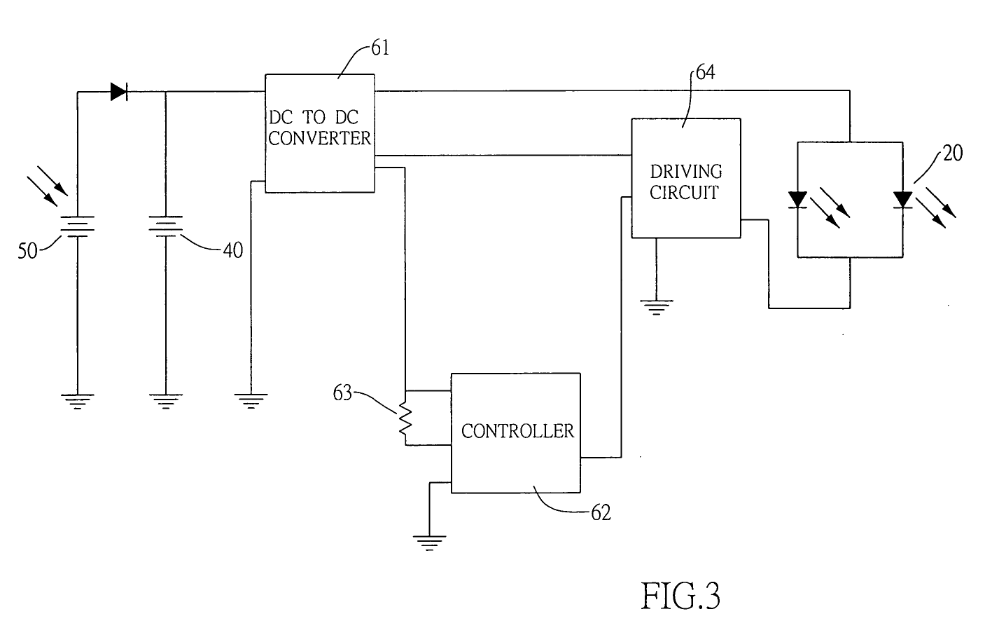

With further reference to FIG. 3, the control circuit is mounted on the circuit panel (30), senses the environment and the state of the rechargeable battery (40), directs an appropriate power source to the light to turn on the light during non-daylight hours and comprises a DC to DC converter (61), a controller (62), a photo resistor (63) and a driving circuit (64).

The DC to DC converter (61) is connected to the rechargeable battery (40) to convert the DC power of the rechargeable battery (40) to multiple different voltage DC power sources and comprises multiple DC power source outputs. One DC power source output of the DC to DC converter (61) is connected to the LEDs (20), so the LEDs obtains a working power.

The controller (62) comprises multiple input terminals and an output terminal. The input terminals are connected to one DC power source output from the DC to DC converter (61) through the photo resistor (63). Therefore, the controller determines whether the sunlight is weak or not according to voltage potential changes of the photo resistor (63).

The driving circuit (64) is connected to another DC power source output from the DC to DC converter (61), the output terminal of the controller (62) and the LEDs (20). When the controller (62) determines the sunlight is weak, the output terminal of the controller (62) outputs a triggering signal to the driving circuit (64) to light on the LEDs (20). On the contrary, the LEDs (20) is not driven by the driving circuit (64) when the sunlight is strong.

With reference to FIG. 2, the streetlight powered by solar energy in accordance with the present invention further comprises a wire (41). The wire (41) is used to connect to an external DC power when the rechargeable battery (40) has no enough DC power.

When there is enough sunlight during the day, the solar array (50) absorbs solar energy and transfers solar energy to electric energy to store electricity in the rechargeable battery (40). When the photo resistor (63) detects that there is not enough light or in the dark, LEDs (20) are lighted on by the rechargeable battery (40). In addition, when the rechargeable battery (40) does not have enough electricity, the wire (41) is connected to the external dc power source to supply power to the LEDs (20).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A streetlight powered by solar energy comprising
a lamppost having
a post having a top end; and
a lampshade mounted on the top end of the post and having a top recess and an open bottom;
a rechargeable battery mounted in the lampshade to store electricity;
a solar array mounted in the top recess in the lampshade, facing away from the lampshade to convert sunlight to direct current (dc) electricity and connected to the rechargeable battery; and
a circuit panel mounted in the lampshade and having
a bottom surface facing the open bottom of the lampshade;
a light mounted on the bottom surface of the circuit panel to receive dc electricity from the rechargeable battery; and
a control circuit mounted on the circuit panel.

2. The streetlight powered by solar energy as claimed in claim 1, wherein the control circuit connects the rechargeable battery to the light and has
a DC to DC converter connected to the rechargeable battery to convert the DC power of the rechargeable battery to multiple different voltage DC power sources and has multiple DC power source outputs;
a photo resistor;
a controller having
multiple input terminals connected to one DC power source output from the DC to DC converter through the photo resistor to determine whether the sunlight is weak or not according to voltage potential changes of the photo resistor;
an output terminal; and
a driving circuit connected to another DC power source output from the DC to DC converter, the output terminal of the controller and the light.

3. The streetlight powered by solar energy as claimed in claim 2, wherein the light is light emitting diodes.

4. The streetlight powered by solar energy as claimed in claim 3, wherein the streetlight has a wire connected to the control circuit on the circuit panel to power the LEDs.
